(19) United States
(12) Patent Application Publication
(10) Pub. No.: US 2018/0268479 A1
(43) Pub. Date: Sep. 20, 2018

(54) INTERNATIONAL TRADE FINANCE BLOCKCHAIN SYSTEM

(71) Applicant: Wells Fargo Bank, N.A., San Francisco, CA (US)

(72) Inventors: Michael D. Dowling, San Francisco, CA (US); Alexander R. Thompson, San Francisco, CA (US); Axel Levitan, San Francisco, CA (US); Robert A. Severino, Irvin, CA (US)

(21) Appl. No.: 15/639,986

(22) Filed: Jun. 30, 2017

Related U.S. Application Data
(60) Provisional application No. 62/357,926, filed on Jul. 1, 2016.

(51) Int. Cl. G06Q 40/02; H04L 9/06

(52) U.S. Cl. CPC G06Q 40/025; G06Q 10/06315; H04L 2209/56; H04L 9/0637

(57) ABSTRACT

A method includes generating a blockchain-based letter of credit (“BLC”) relating to a contract for a trade transaction between a seller and a buyer. The BLC defines documentary and supply chain flow payment trigger events. The BLC is stored and accessible via a blockchain. A plurality of documentary flow events related to the BLC are tracked and recorded on the blockchain, and are linked to the BLC. A plurality of supply chain flow events related to a physical status of a good involved in the trade transaction are tracked and recorded on the blockchain. Each of the plurality of supply chain flow events are linked to the BLC. Payment for the contract for the trade transaction is transferred to the seller in response to detecting occurrence of both of the documentary and supply chain flow events corresponding to the respective documentary and supply chain flow payment trigger events.

### CROSS-REFERENCE TO RELATED APPLICATIONS

This application claims the benefit of priority to U.S. Application No. 62/357,926, filed Jul. 1, 2016, entitled “INTERNATIONAL TRADE FINANCE BLOCKCHAIN SYSTEM,” which is hereby incorporated by reference in its entirety.

### BACKGROUND

Trade transactions can involve the sale of goods or services from a seller to a buyer. Financial intermediaries such as banks and other financial institutions can facilitate these transactions by financing the trade.

A letter of credit (“LC”) is one example of a trade finance service that is used to facilitate trade transactions, such as international trade transactions. An LC is a bank-issued document that assures that a seller will receive payment up to a certain amount, as long as certain conditions have been met by the seller. If a buyer is unable to make payment to the seller (and those conditions have been met), the LC allows the seller to demand payment from the bank, and the bank is required to cover the remaining amount owed. LCs effectively substitute the buyer's credit for the bank's credit, allowing the bank to act as an intermediary between the buyer and the seller. Currently, LCs are largely paper-based, require individual review, and lack the capability for buyers and sellers to obtain real-time status information or tracking data. Accordingly, current LCs lack security, transparency, and access capabilities.

### SUMMARY

Various embodiments relate to a computer-implemented method, including generating a blockchain-based letter of credit (“BLC”) relating to a contract for a trade transaction between a seller and a buyer. The BLC defines a documentary flow payment trigger event and a supply chain flow payment trigger event. The BLC is stored on a blockchain. The BLC is accessible by each of the seller and the buyer to view a status of the trade transaction. A plurality of documentary flow events related to the BLC are tracked. In response to detecting occurrence of each of the plurality of documentary flow events, the respective documentary flow events are recorded on the blockchain. Each of the plurality of documentary flow events are linked to the BLC. A plurality of supply chain flow events are tracked. Each of the plurality of supply chain flow events are related to a physical status of a good involved in the trade transaction. In response to detecting occurrence of each of the plurality of supply chain flow events, the respective supply chain flow events are recorded on the blockchain. Each of the plurality of supply chain flow events are linked to the BLC. Payment for the contract for the trade transaction is transferred to the seller in response to detecting occurrence of both of the documentary flow event corresponding to the documentary flow payment trigger event and the supply chain flow event corresponding to the supply chain flow payment trigger event.

Various other embodiments relate to a computing system, including a trade financing circuit structured to generate a BLC relating to a contract for a trade transaction between a seller and a buyer. The BLC defines a documentary flow payment trigger event and a supply chain flow payment trigger event. A blockchain circuit is structured to store the BLC on a blockchain. The BLC is accessible by each of the seller and the buyer to view a status of the trade transaction. An event circuit structured to track a plurality of documentary flow events related to the BLC. In response to detecting occurrence of each of the plurality of documentary flow events, the tracked documentary flow events are recorded on the blockchain. Each of the plurality of documentary flow events are linked to the BLC. The event circuit is also structured to track a plurality of supply chain flow events. Each of the plurality of supply chain flow events being related to a physical status of a good involved in the trade transaction. In response to detecting occurrence of each of the plurality of supply chain flow events, the tracked supply chain flow events are recorded on the blockchain. Each of the plurality of supply chain flow events are linked to the BLC. The trade financing circuit is further structured to, in response to detecting occurrence of both of a first documentary flow event of the plurality of documentary flow events corresponding to the documentary flow payment trigger event and a first supply chain flow event of the plurality of supply chain flow events corresponding to the supply chain flow payment trigger event, transfer payment for the contract for the trade transaction to the seller.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is a block diagram illustrating a system structured to perform a commercial trade finance transaction using a BLC, according to an example embodiment.

FIG. 2 is a block diagram of the trade finance blockchain computing system of FIG. 1, according to an example embodiment.

### DETAILED DESCRIPTION

Conventional trade finance systems, such as those facilitating LCs, operate based on a flow of documents between parties and banks, which may be referred to as a “documentary flow.” The documentary flow includes a series of steps involving the transfer, analysis, and approval of certain documents. Each step must be completed in order to satisfy the requirements of the LC, and to ultimately release payment for the trade transaction.

Supply chain management (“SCM”) systems are used to track the flow of goods. For example, SCM systems may be used to track the movement and storage of raw materials, work-in-process inventory, and finished goods from point of origin to point of consumption. This movement of goods may be referred to as a “supply chain flow.” SCM systems may be automated in whole or in part. For example, barcode or radio frequency identification (“RFID”) tags and scanners may be used to track the location of goods at certain points throughout the supply chain, such as during various steps of manufacturing, packaging, warehousing, shipping, customs, delivery, etc.

Current trade finance systems and SCM systems are not integrated. Therefore, the documentary flow needed to facilitate trade financing is completely divorced from the supply chain flow needed to manage manufacturing and delivery of goods. Accordingly, current systems lack the ability to analyze the progress of the documentary flow relative to the progress of the supply chain flow of the goods.

Various embodiments relate to systems and methods for trade financing via a blockchain-based system. The system is structured to generate a BLC, which is a trade financing mechanism for a contract for a trade transaction between a seller to a buyer. The BLC includes some similarities to a conventional LC. However, as will be appreciated, the BLC includes several features that enable significantly enhanced functionality compared to a conventional LC. The BLC may be structured as a smart contract and stored on a blockchain. By structuring the BLC as a smart contract stored on a blockchain, documentary risk is decreased significantly compared to conventional paper-based LCs. As will be appreciated, this enables partial and incremental financing to the seller earlier than in conventional trade financing systems.

With traditional trade financing transactions, the supply chain flow happens independently from the document flow, and the two flows are not linked. Various embodiments relate to systems and methods of linking the supply chain flow of a trade transaction with the documentary flow. This provides the ability to track significant events along the supply chain flow, which in turn enables a bank to identify different levels of risk associated with trade financing. In some embodiments, supply chain flow is tracked by monitoring received status messages that indicate the physical status of the goods. For example, in some embodiments, a wireless transmitter is attached to the goods, which periodically transmits status messages indicating the geolocation of the goods. In some embodiments, the wireless transmitter is part of an internet of things (“IoT”) device. In some embodiments, a BLC is linked to one or more single physical events based on one or more received status messages. In other embodiments, the BLC is linked to a multi-phase geospatial plan, and information may be retrieved regarding any phase of the plan.

Various embodiments also relate to trade financing via a variable trade financing profile. An example variable trade financing profile may include several incremental partial payment amounts triggered by monitored documentary and/or supply chain flow events. The ability to monitor documentary and supply chain flow throughout the lifecycle of the trade financing transaction enables enhanced analysis of documentary risk and supply chain risk at improved levels of granularity. In addition, linking the documentary flow events with the supply chain flow events enables overall dynamic trade financing risk to be analyzed at levels of granularity and accuracy not previously available. By better analyzing risk, banks may provide superior trade financing products, resulting in lower cost and better performance for the customer. For example, in one embodiment, a variable trade financing profile defines levels of incremental funding provided as the trade transaction progresses. In another embodiment, a variable trade financing profile defines an interest rate that is reduced as the trade transaction progresses.

Various embodiments further relate to securitization of BLCs. The BLCs are securitized based on one or more documentary and/or supply chain flow events. The BLC securities may be priced according to the documentary, supply chain, and/or overall trade finance risk associated with the location of the events within the overall flows. Some embodiments relate to a marketplace for trading BLC securities. The marketplace provides the ability to on-sale trade finance risk to other banks and insurance companies, or sell-down un-funded trade finance confirmations. In some embodiments, the marketplace can receive current (legacy) paper-based LCs in addition to BLCs so as to create an asset pool quickly and attract other banks to the market to provide liquidity.

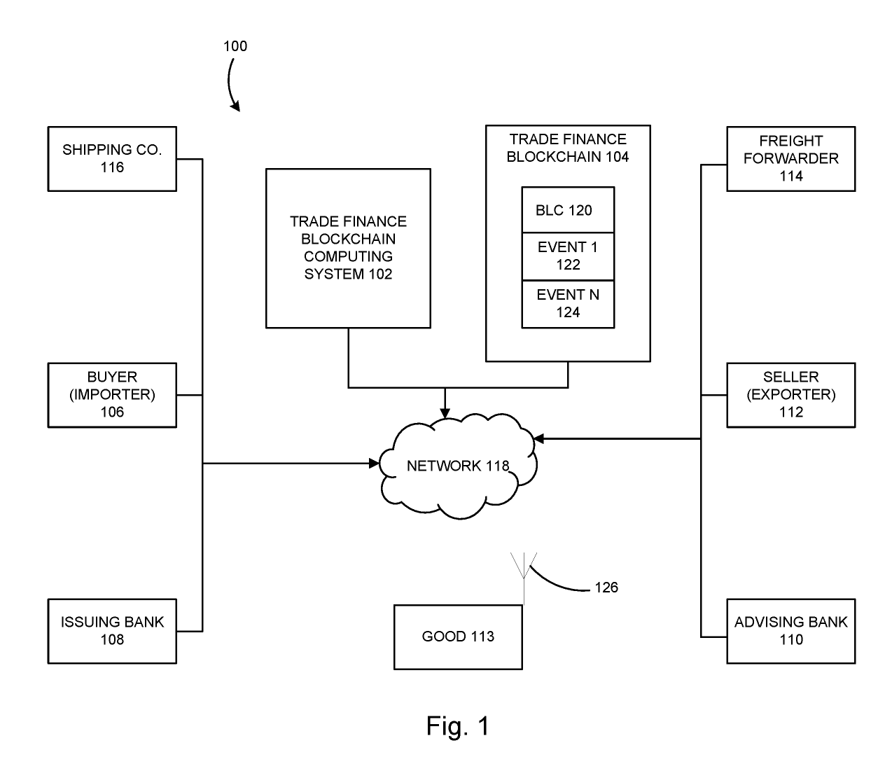

FIG. 1 is a block diagram illustrating a system 100 structured to perform a commercial trade finance transaction using a BLC, according to an example embodiment. The system 100 includes trade finance blockchain computing system 102, a trade finance blockchain 104, a buyer 106, an issuing bank 108, an advising bank 110, a seller 112, a good 113, a freight forwarder 114, and a shipping company 116, each being in operative communication via a network 118. By way of example, the system 100 will be described in connection with an international trade finance transaction involving the seller 112 exporting the good 113 from a first country and the buyer 106 importing the good 113 into a second country.

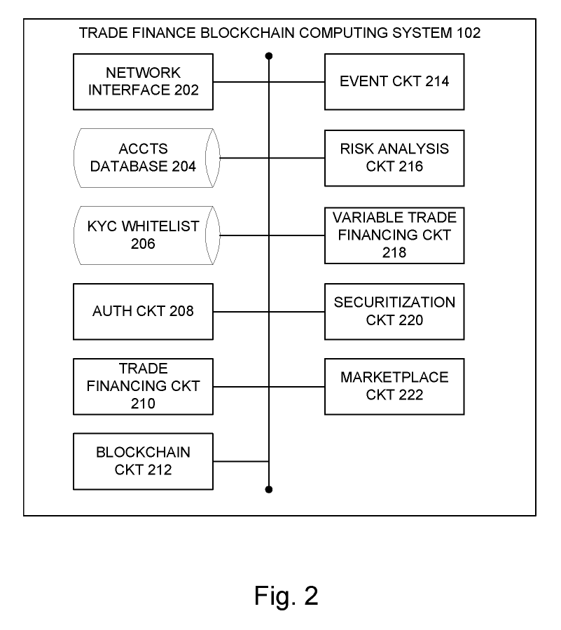

The trade finance blockchain computing system 102 is structured to facilitate and manage trade finance products and services, such as BLCs. Detailed components of the trade finance blockchain computing system 102 are described in further detail in connection with FIG. 2. In some embodiments, the trade finance blockchain computing system 102 is managed by a financial institution, such as a bank. For example, in some embodiments, the trade finance blockchain computing system 102 is managed by one of the issuing bank 108 and the advising bank 110. In other embodiments, the trade finance blockchain computing system 102 is managed by a governmental entity or a third-party.

The trade finance blockchain 104 is a distributed ledger including all of the information (e.g., trade financing transactions, records, and other related information, among other things) that has been stored in the trade finance blockchain 104 since its genesis. The trade finance blockchain 104 may be similar to other blockchains, such as those used for math-based currencies, or may be built on top of a math-based currency blockchain. The trade finance blockchain 104 hashes transactions (e.g., trade finance transactions, events, etc.) into an ongoing chain of hash-based proof-of-work, forming a record that cannot be changed without redoing the proof-of-work. The longest chain not only serves as proof of the sequence of events witnessed, but proof that it came from the largest pool of CPU power (e.g., operated by verification nodes). The proof-of-work requirement ensures that entries in the blockchain are not compromised. In some embodiments, verification nodes are paid for their mining activities via minimal transaction fees. Other embodiments use a consensus mechanism other than proof-of-work, such as proof-of-stake, Byzantine fault tolerance, federated consensus, etc.

In some embodiments, the trade finance blockchain 104 is a private and permissioned blockchain platform in which verification nodes are preselected by a central authority (e.g., the trade finance blockchain computing system 102 or another entity). In other embodiments, the trade finance blockchain 104 is a public and permissionless ledger. In one embodiment, the trade finance blockchain 104 is purpose-built to maintain compatibility with existing applications.

As illustrated in FIG. 1, the trade finance blockchain 104 includes a BLC 120. The BLC 120 includes the terms and conditions of a BLC defined by the trade finance blockchain computing system 102 in response to a request by the buyer 106. The BLC 120 also includes several events, including a first event 122 to an N^{th} event 124, associated with the BLC 120. For example, as will be appreciated, the first event 122 may include a documentary flow event and the N^{th} event 124 may include a supply chain flow event. The first to N^{th} events 122, 124 are added to the trade finance blockchain 104 as they occur. The BLC 120 and its associated first to N^{th} events 122, 124 may be linked based on a transaction identifier, an identifier of the buyer 106, or other types of unique identifiers. Accordingly, the trade finance blockchain 104 maintains a complete and immutable record of each BLC 120 and its associated first to N^{th} events 122, 124.

The embodiments described herein provide significant technical advantages over conventional trade financing systems. For example, by structuring the BLC 120 as a smart contract stored on a blockchain, documentary risk is decreased significantly compared to conventional paper-based LCs. In some embodiments, the BLCs 120 can also work with electronic documents for one bank and paper documents for a correspondent bank. The BLCs 120 also enable human review and straight-through processing (“STP”).

BLCs 120 also work with one-sided support, whereas other electronic trade financing mechanisms, such as bank payment obligations (“BPOs”) do not work with one-sided support. Instead, BPOs are only possible if both a buyer's bank and a seller's bank support BPOs. In contrast, BLCs 120 can be utilized in situations in which only one of the buyer's bank and the seller's bank support BLCs 120.

Structuring the BLC 120 as a smart contract stored on a blockchain provides enhanced customer visibility into the transaction status. With current LC systems, customers are often frustrated regarding the lack of transaction status information that is available once documents have been submitted. In contrast, BLCs 120 offer real-time visibility of transaction status information for all participants at every stage of the transaction. Other advantages of structuring the BLC 120 as a blockchain-based smart contract include providing an immutable audit trail, enabling participants rights management, and facilitating transfer and assignment of BLCs 120.

The buyer 106 is a party applying for the issuance of the BLC 120, and may also be referred to as the “applicant.” The buyer 106 is the party importing the good 113. In this example, the buyer 106 has a bank account with the issuing bank 108.

The issuing bank 108 issues the LC and takes the responsibility to make payment to the seller 112.

The advising bank 110 advises the seller 112 about the credit that is opened his favor.

The seller 112 is the party in whose favor the LC is issued, and who will receive payment if all the conditions and terms of the BLC 120 are met. The seller 112 may also be referred to as the “beneficiary.” The seller 112 is the party exporting the good 113. In this example, the seller 112 has a bank account with the advising bank 110.

The buyer 106 and the seller 112 have agreed on terms and conditions of transactions that will help construct LCs and BLCs. A purchase order is already in existence or in process of negotiation between the buyer 106 and the seller 112. The international trade finance transaction is completed using the BLC 120.

The good 113 is the product that is the subject of the BLC 120, and is being sold by the seller 112 to the buyer 106. In some embodiments, the good 113 includes a transmitter 126 for transmitting a physical status of the good 113 within a supply chain flow to the trade finance blockchain computing system 102. For example, the transmitter 126 may transmit a geolocation of the good 113 to the trade finance blockchain computing system 102. In some embodiments, the transmitter 126 is an RFID tag. In some embodiments, the good 113 includes a one- or two-dimensional barcode in addition to or instead of the transmitter 126. In such embodiments, the barcode is scanned using a scanner at various points during the supply chain process, and the physical status information is transmitted to the trade finance blockchain computing system 102. The transmitter 126 or barcode may be integrated or attached to the packaging of the good 113, or may be integral to the good 113.

FIG. 2 is a block diagram of the trade finance blockchain computing system 102 of FIG. 1, according to an example embodiment. The trade finance blockchain computing system 102 includes a network interface 202, an accounts database 204, a KYC whitelist 206, an authorization circuit 208, a trade financing circuit 210, a blockchain circuit 212, an event circuit 214, a risk analysis circuit 226, a variable trade financing circuit 218, a securitization circuit 220, and a marketplace circuit 222.

The network interface 202 is structured to facilitate operative communication between the trade finance blockchain computing system 102 and the other systems and devices of the system 100 of FIG. 1 via the network 118.

The accounts database 204 is a storage repository including account information of the various users (e.g., entities, such as corporations, organizations, individuals, etc.) of the system 100, such as the buyer 106 and the seller 112. In some embodiments, users must go through an on-boarding process, including KYC verification, to create an account with the trade finance blockchain computing system 102 in order to use the system 100. In some embodiments, the trade finance blockchain computing system 102 receives account information from a financial institution with which a user has an account. For example, the trade finance blockchain computing system 102 may receive account information from the advising bank 110 regarding the seller 112.

The KYC whitelist 206 is a list of entities that have been determined by the trade finance blockchain computing system 102 to comply with KYC requirements. The entities included in the KYC whitelist 206 may, but need not, be registered account holders of the trade finance blockchain computing system 100. If an entity intending to use the system 100 as a buyer or a seller is not included in the KYC whitelist 206, the entity may be required to provide certain information to comply with KYC requirements.

The authorization circuit 208 is structured to verify and authenticate identities of users of the system 100. The authorization circuit 208 may utilize any number of authentication mechanisms, such as a username and password, cryptographic key exchange, etc. to verify and authenticate the identity of an entity that has an account with the trade finance blockchain computing system 102. Users of the system 100 may include any of the buyers 106 and sellers 112, banks and financial institutions such as the issuing bank 108 and the advising bank 110, logistics partners such as the freight forwarder 114 and the shipping company 116, and any other user of the system 100.

The trade financing circuit 210 is structured to create and manage trade finance mechanisms, such as BLCs 120. In some embodiments, the buyer 106 interfaces directly with the trade finance blockchain computing system 102 to request to create the BLC 120. The trade finance blockchain computing system 102 processes the request and sends the request to the issuing bank 108. However, in other embodiments, the buyer 106 may interface with the issuing bank 108 and the issuing bank may instruct the trade finance blockchain computing system 102 to create the BLC 120. The request to create the BLC 120 may include various documents and other details regarding the terms of the trade transaction contract, such as payment terms, shipment terms, and additional information.

In some embodiments, the trade financing circuit 210 interfaces with a third-party system to create BLCs 120. For example, in some embodiments, the buyer 106 interfaces with the third-party system to create a smart contract associated with the BLC. For example, in some embodiments, the third-party creates a bracket-based obligation (“BBO”) based on a request received from the buyer 106. The third-party system may send a request for approval of the BBO to the issuing bank 108, and may generate the BLC 120 upon receiving approval. In such embodiments, the trade financing circuit 210 may monitor and manage performance of the BLC 120.

The trade financing circuit 210, in cooperation with the event circuit 214, is also structured to analyze metadata and other data associated with tracked documentary flow events (e.g., executed documents) and supply chain event messages to track compliance with various requirements or milestones of the BLCs 120. Because the BLCs 120 are structured as smart contracts, the trade financing circuit 210 facilitates performance of clauses of the BLCs 120 by providing notification of events specified in the BLCs 120.

According to various embodiments, the BLC 120 may define certain documentary flow events and/or supply chain flow events as triggering payments, risk calculations, and interest rate adjustments, among other things. For example, a documentary flow payment trigger event and a supply chain flow payment trigger event may define the final events in the contract. In one embodiment, the BLC 120 is structured to transfer payment for the contract in response to detecting occurrence of both of the documentary flow payment trigger event and the supply chain flow payment trigger event. In some embodiments, the BLC 120 is structured to transfer payment for the contract, in whole or in part, in response to detecting occurrence of one of the documentary flow payment trigger event and the supply chain flow payment trigger event.

The blockchain circuit 212 is structured to format, store, and maintain BLCs 120 and the first to N^{th} events 122, 124 on the trade finance blockchain 104. The blockchain circuit 212 may also manage mining activities of the verification nodes. The blockchain circuit 212 may interface with the authorization circuit 208 to manage access to the information on the trade finance blockchain 104 in implementations in which the trade finance blockchain 104 is a permissioned ledger.

The event circuit 214 is structured to monitor messages, documents, and other data received by the trade finance blockchain computing system 102 to track, identify, and record documentary and supply chain events. The messages and documents may include metadata or other data that indicates the BLC 120 or parties with which the messages and documents are associated. The event circuit 214 processes the messages and documents to determine occurrence of and compliance with events specified in the associated BLC 120.

The risk analysis circuit 226 is structured to analyze documentary, supply chain, and overall trade financing risk associated with performance of the BLC 120. For example, documentary risks may include fraud risk to the buyer 106 and to the seller 112. For example, documentary fraud to the buyer 106 may occur if the beneficiary (e.g., the seller 112) of a certain LC transaction prepares fake documents, which may appear on their face to comply, to make the presentation to the issuing bank 108. Documentary fraud to the seller 112 may occur if the buyer 106 issues a counterfeit LC. In this case, the seller 112 never receives its payment for the goods 113 it has shipped.

Supply chain risks may include risks to the buyer 106, the seller 112, and to the issuing and advising banks 108, 110. For example, supply chain fraud to the buyer 106 may occur if the importer does not get delivery, if the goods 113 are received with inferior quality, if the exchange rate fluctuates excessively, or if the issuing bank 108 declares bankruptcy. Supply chain fraud to the seller 112 may occur, for example, if the exporter is unable to comply with LC conditions, if the LC is counterfeit, if the issuing bank 108 fails, or if the issuing bank's 108 country experiences turmoil. Supply chain risks may further range from unpredictable natural threats to fake replicas of products, and reach across quality and security, to resiliency and product integrity. Risks may further include country and/or political risk due to changes to a country's export regime, or mass riots, civil war, boycott, and also due to sovereign risk and transfer risk. Further, every bank involved in the LC transaction maintains/bears some level of risk depending on how much they are involved in the transaction. In general, risk increases as responsibility of the bank increases.

In general, risks decrease over time as portions of a BLC 120 are completed. For example, documentary risks decrease as the trade finance blockchain computing system 102 receives, verifies, and authenticates documents associated with the BLC 120. Similarly, supply chain risks decrease as the good 113 progresses through the supply chain. To this end, the risk analysis circuit 226 is tasked with analyzing the various risks associated with the BLC 120 over time. For example, in one embodiment, the risk analysis circuit 216 is structured to assign a first risk level associated with the trade transaction prior completion of one of the documentary or supply chain flow events, and a second risk level associated with the trade transaction after completion of one of the documentary and/or supply chain flow events. In effect, the difference between the first and second risk levels represents the risk that the corresponding documentary or supply chain flow events will not occur. The risk analysis circuit 216 may define risk levels associated with any of the documentary and supply chain flow events identified in the BLC 120. As will be appreciated, the risk levels may be utilized to trigger interest rate adjustments, partial payments, or pricing of securities associated with the BLC 120.

The variable trade financing circuit 218 is structured to manage variable trade financing profiles, which may be associated with certain BLCs 120. Variable trade financing profiles may include several incremental partial payment amounts triggered by monitored documentary and/or supply chain flow events. In some implementations, the variable trade financing profiles include dynamic (e.g., real-time, near real-time, or periodic) payments or interest rate adjustments based on the risks analyzed by the risk analysis circuit 226.

It is important to note that analysis of documentary and supply chain risks over time by the risk analysis circuit 226 and variable trade financing analysis by the variable trade financing circuit 218 enable the trade finance blockchain computing system 102 to provide significant technical advantages over existing trade finance systems. For example, linking the documentary flow events with the supply chain flow events enables overall dynamic trade financing risk to be analyzed at levels of granularity and levels of accuracy not previously available.

For example, existing trade financing systems may include a limited number of flow event data points, may have a significant lag in data receipt, and/or may not be capable of linking documentary flow events with supply chain flow events. Accordingly, existing trade financing systems are incapable of understanding true trade financing risks at discrete points in the process. This lack of understanding prevents banks from providing the best value product to each customer. In contrast, the dynamic risk analysis provided by the instant concept enables optimal pricing to be provided to customers.

According to various embodiments, the variable trade financing circuit 218 is structured to define a trade financing profile for the BLC 120. The trade financing profile may define partial payments that are transferred automatically upon detecting occurrence of one or more documentary and/or supply chain flow events. For example, in one embodiment, the trade financing profile specifies a first partial payment for the contract upon occurrence of at least one of a first partial documentary flow payment trigger event and a first partial supply chain flow payment trigger event. The variable trade financing circuit 218 is also structured to transfer the first partial payment to the seller in response to detecting occurrence of the at least one of the documentary flow event and the supply chain flow event corresponding to the at least one of the first partial documentary flow payment trigger event and the first partial supply chain flow payment trigger event. In some embodiments, the at least one of the first partial documentary flow payment trigger event and the first partial supply chain flow payment trigger event occur prior to the respective documentary flow payment trigger event and the supply chain flow payment trigger event that trigger full payment.

In some embodiments, the variable trade financing circuit 218, in connection with the risk analysis circuit 216, is structured to define a trade financing profile for the BLC 120 based at least in part on risk levels associated with certain documentary and supply chain flow events. For example, in one embodiment, the trade financing profile includes a first risk level associated with the trade transaction prior to completion of a second documentary flow event of the plurality of documentary flow events, and a second risk level associated with the trade transaction after completion of the second documentary flow event of the plurality of documentary flow events. The trade financing profile also includes a first interest rate associated with the first risk level, and a second interest rate associated with the second risk level. The variable trade financing circuit 218 is structured to transfer a first partial payment to the seller based on one of the first and second interest rates in response to detecting occurrence of the second documentary flow event.

In another embodiment, the trade financing profile includes a first risk level associated with the trade transaction prior to completion of a second supply chain flow event of the plurality of supply chain flow events, and a second risk level associated with the trade transaction after completion of the second supply chain flow event of the plurality of supply chain flow events. The trade financing profile also includes a first interest rate associated with the first risk level, and a second interest rate associated with the second risk level. The variable trade financing circuit 218 is structured to transfer a first partial payment to the seller based on one of the first and second interest rates in response to detecting occurrence of the second supply chain flow event.

The securitization circuit 220 is structured to facilitate securitization of the BLCs 120. The BLCs 120 may be securitized based on one or more documentary and/or supply chain flow events. The BLC securities may be priced according to the documentary, supply chain, or overall trade finance risk associated with the location of the events within the overall flows.

More specifically, the securitization circuit 220 is structured to create a security backed by one or more of the BLCs 120. The security maintains the links between the trade financing profiles of the individual BLCs 120 and the documentary and supply chain events that trigger payment, interest rate calculations, etc. in response to detecting occurrence of the corresponding events.

In some embodiments, the securitization circuit 220 dynamically prices the security based on the status of its underlying BLCs 120. For example, in one embodiment, the trade financing profile for one of the BLCs 120 backing the security includes a first risk level associated with the trade transaction prior to completion of a second documentary or supply chain flow event, and a second risk level associated with the trade transaction after completion of the second documentary or supply chain flow event. The securitization circuit 220 prices the BLC security at a first price prior to detecting occurrence of the second documentary or supply chain flow event, with the first price being based on the first risk level. The securitization circuit 220 prices the BLC security at a second price in response to detecting occurrence of the second documentary or supply chain flow event, with the second price being based on the second risk level. In practice, the second price will likely be lower than the first price because the first and second risk levels specify that there is a higher risk of the trade transaction failing before versus after occurrence of the second documentary or supply chain flow event.

The marketplace circuit 222 is structured to operate and manage a marketplace for trading BLC securities. The marketplace provides the ability to on-sale trade finance risk to other banks and insurance companies, or sell-down un-funded trade finance confirmations. In some embodiments, the marketplace can receive current (legacy) paper-based LCs, in addition to BLCs so as to create an asset pool quickly and attract other banks to the market to provide liquidity.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A computer-implemented method, comprising:
generating a blockchain-based letter of credit (“BLC”) relating to a contract for a trade transaction between a seller and a buyer, the BLC defining a documentary flow payment trigger event and a supply chain flow payment trigger event;
storing the BLC on a blockchain, wherein the BLC is accessible by each of the seller and the buyer to view a status of the trade transaction;
tracking a plurality of documentary flow events related to the BLC;
in response to detecting occurrence of each of the plurality of documentary flow events, recording the tracked documentary flow events on the blockchain, each of the plurality of documentary flow events being linked to the BLC;
tracking a plurality of supply chain flow events, each of the plurality of supply chain flow events being related to a physical status of a good involved in the trade transaction;
in response to detecting occurrence of each of the plurality of supply chain flow events, recording the tracked supply chain flow events on the blockchain, each of the plurality of supply chain flow events being linked to the BLC; and
in response to detecting occurrence of both of a first documentary flow event of the plurality of documentary flow events corresponding to the documentary flow payment trigger event and a first supply chain flow event of the plurality of supply chain flow events corresponding to the supply chain flow payment trigger event, transferring payment for the contract for the trade transaction to the seller.

2. The method of claim 1, wherein each of the plurality of supply chain events are tracked based on received data packets indicating the physical status of the good, the physical status of the good relating to a physical location of the good.

3. The method of claim 1, wherein the BLC includes a smart contract structured to automatically trigger payment transfer upon the occurrence of at least one of the plurality of documentary and supply chain flow events.

4. The method of claim 1, wherein the payment is transferred via a math-based currency transaction on the blockchain.

5. The method of claim 1, further comprising:
defining a know your customer (“KYC”) whitelist including a plurality of entities determined to comply with KYC requirements; and
preventing generation of the BLC if one of the seller and buyer is not included in the KYC whitelist.

6. The method of claim 1, further comprising:
defining a trade financing profile for the BLC, the trade financing profile specifying a first partial payment for the contract upon occurrence of at least one of a first partial documentary flow payment trigger event and a first partial supply chain flow payment trigger event; and
transferring the first partial payment to the seller in response to detecting occurrence of at least one of the first partial documentary flow payment trigger event and the first partial supply chain flow payment trigger event,
wherein the at least one of the first partial documentary flow payment trigger event and the first partial supply chain flow payment trigger event occur prior to the respective documentary flow payment trigger event and the supply chain flow payment trigger event.

7. The method of claim 1, further comprising:
defining a trade financing profile for the BLC, the trade financing profile comprising:
a first risk level associated with the trade transaction prior to completion of a second documentary flow event of the plurality of documentary flow events,
a second risk level associated with the trade transaction after completion of the second documentary flow event of the plurality of documentary flow events,
a first interest rate associated with the first risk level, and
a second interest rate associated with the second risk level; and
transferring a first partial payment to the seller based on one of the first and second interest rates in response to detecting occurrence of the second documentary flow event.

8. The method of claim 1, further comprising:
defining a trade financing profile for the BLC, the trade financing profile comprising:
a first risk level associated with the trade transaction prior to completion of a second supply chain flow event of the plurality of supply chain flow events,
a second risk level associated with the trade transaction after completion of the second supply chain flow event of the plurality of supply chain flow events,
a first interest rate associated with the first risk level, and
a second interest rate associated with the second risk level; and
transferring a first partial payment to the seller based on one of the first and second interest rates in response to detecting occurrence of the second supply chain flow event.

9. The method of claim 1, further comprising:
defining a trade financing profile for the BLC, the trade financing profile comprising:
a first risk level associated with the trade transaction prior to completion of a second documentary flow event of the plurality of documentary flow events, and
a second risk level associated with the trade transaction after completion of the second documentary flow event of the plurality of documentary flow events;
creating a BLC security backed by the BLC;
pricing the BLC security at a first price prior to detecting occurrence of the second documentary flow event, the first price being based on the first risk level; and
pricing the BLC security at a second price in response to detecting occurrence of the second documentary flow event, the second price being based on the second risk level, and the second price being lower than the first price.

10. The method of claim 1, further comprising:
defining a trade financing profile for the BLC, the trade financing profile comprising:
a first risk level associated with the trade transaction prior to completion of a second supply chain flow event of the plurality of supply chain flow events, and
a second risk level associated with the trade transaction after completion of the second supply chain flow event of the plurality of supply chain flow events;
creating a BLC security backed by the BLC;
pricing the BLC security at a first price prior to detecting occurrence of the second supply chain flow event, the first price being based on the first risk level; and
pricing the BLC security at a second price in response to detecting occurrence of the second supply chain flow event, the second price being based on the second risk level, and the second price being lower than the first price.

11. A computing system, comprising:
a trade financing circuit structured to generate a blockchain-based letter of credit (“BLC”) relating to a contract for a trade transaction between a seller and a buyer, the BLC defining a documentary flow payment trigger event and a supply chain flow payment trigger event;
a blockchain circuit structured to store the BLC on a blockchain, wherein the BLC is accessible by each of the seller and the buyer to view a status of the trade transaction;
an event circuit structured to:
track a plurality of documentary flow events related to the BLC,
in response to detecting occurrence of each of the plurality of documentary flow events, record the tracked documentary flow events on the blockchain, each of the plurality of documentary flow events being linked to the BLC,
track a plurality of supply chain flow events, each of the plurality of supply chain flow events being related to a physical status of a good involved in the trade transaction, and
in response to detecting occurrence of each of the plurality of supply chain flow events, record the tracked supply chain flow events on the blockchain, each of the plurality of supply chain flow events being linked to the BLC; and
the trade financing circuit further structured to, in response to detecting occurrence of both of a first documentary flow event of the plurality of documentary flow events corresponding to the documentary flow payment trigger event and a first supply chain flow event of the plurality of supply chain flow events corresponding to the supply chain flow payment trigger event, transfer payment for the contract for the trade transaction to the seller.

12. The system of claim 11, wherein the event circuit is structured to track each of the plurality of supply chain events based on received data packets indicating the physical status of the good, the physical status of the good relating to a physical location of the good.

13. The system of claim 11, wherein the BLC includes a smart contract structured to automatically trigger payment transfer upon the occurrence of at least one of the plurality of documentary and supply chain flow events.

14. The system of claim 11, wherein the payment is transferred via a math-based currency transaction on the blockchain.

15. The system of claim 11, further comprising a know your customer (“KYC”) circuit structured to:
define a KYC whitelist including a plurality of entities determined to comply with KYC requirements; and
prevent generation of the BLC if one of the seller and buyer is not included in the KYC whitelist.

16. The system of claim 11, further comprising a variable trade financing circuit structured to:
define a trade financing profile for the BLC, the trade financing profile specifying a first partial payment for the contract upon occurrence of at least one of a first partial documentary flow payment trigger event and a first partial supply chain flow payment trigger event; and
transfer the first partial payment to the seller in response to detecting occurrence of the at least one of the documentary flow event and the supply chain flow event corresponding to the at least one of the first partial documentary flow payment trigger event and the first partial supply chain flow payment trigger event,
wherein the at least one of the first partial documentary flow payment trigger event and the first partial supply chain flow payment trigger event occur prior to the respective documentary flow payment trigger event and the supply chain flow payment trigger event.

17. The system of claim 11, further comprising a variable trade financing circuit structured to:
define a trade financing profile for the BLC, the trade financing profile comprising:
a first risk level associated with the trade transaction prior to completion of a second documentary flow event of the plurality of documentary flow events,
a second risk level associated with the trade transaction after completion of the second documentary flow event of the plurality of documentary flow events,
a first interest rate associated with the first risk level, and
a second interest rate associated with the second risk level; and
transfer a first partial payment to the seller based on one of the first and second interest rates in response to detecting occurrence of the second documentary flow event.

18. The system of claim 11, further comprising a variable trade financing circuit structured to:
define a trade financing profile for the BLC, the trade financing profile comprising:
a first risk level associated with the trade transaction prior to completion of a second supply chain flow event of the plurality of supply chain flow events,
a second risk level associated with the trade transaction after completion of the second supply chain flow event of the plurality of supply chain flow events,
a first interest rate associated with the first risk level, and
a second interest rate associated with the second risk level; and
transfer a first partial payment to the seller based on one of the first and second interest rates in response to detecting occurrence of the second supply chain flow event.

19. The system of claim 11, further comprising a variable trade financing circuit structured to:
define a trade financing profile for the BLC, the trade financing profile comprising:
a first risk level associated with the trade transaction prior to completion of a second documentary flow event of the plurality of documentary flow events, and
a second risk level associated with the trade transaction after completion of the second documentary flow event of the plurality of documentary flow events;
creating a BLC security backed by the BLC;
price the BLC security at a first price prior to detecting occurrence of the second documentary flow event, the first price being based on the first risk level; and
price the BLC security at a second price in response to detecting occurrence of the second documentary flow event, the second price being based on the second risk level, and the second price being lower than the first price.

20. The system of claim 11, further comprising a securitization circuit structured to:
define a trade financing profile for the BLC, the trade financing profile comprising:
a first risk level associated with the trade transaction prior to completion of a second supply chain flow event of the plurality of supply chain flow events, and
a second risk level associated with the trade transaction after completion of the second supply chain flow event of the plurality of supply chain flow events;
create a BLC security backed by the BLC;
price the BLC security at a first price prior to detecting occurrence of the second supply chain flow event, the first price being based on the first risk level; and
price the BLC security at a second price in response to detecting occurrence of the second supply chain flow event, the second price being based on the second risk level, and the second price being lower than the first price.
